(19) United States
(12) Patent Application Publication
(10) Pub. No.: US 2018/0038144 A1
(43) Pub. Date: Feb. 8, 2018

(54) WINDOW FRAMING SYSTEM WITH THREE MAIN EXTRUSIONS

(71) Applicant: Dean Metzger, Berkeley, CA (US)

(72) Inventor: Dean Metzger, Berkeley, CA (US)

(21) Appl. No.: 15/669,245

(22) Filed: Aug. 4, 2017

Related U.S. Application Data
(60) Provisional application No. 62/371,654, filed on Aug. 5, 2016.
(60) Provisional application No. 62/421,228, filed on Nov. 12, 2016.

(51) Int. Cl. E05D 15/06; E06B 3/26; E06B 1/36; E05F 5/00; E05D 15/16; E06B 3/54; E06B 3/964

(52) U.S. Cl. CPC E05D 15/0665; E06B 3/5454; E06B 3/26; E06B 3/964; E05F 5/003; E05D 15/16; E06B 1/36; E05Y 2900/148

(57) ABSTRACT

A window system for manufacturing fixed windows using only two main extrusions, a main frame, and sash frame; and for manufacturing vertical and horizontal sliding windows using only three main extrusions, a main frame, a sash frame, and an interlock. This overcomes the disadvantages of existing window assemblies that currently need multiple extrusions, and results in reduced retooling costs, permitting manufacture of window systems using newer, more energy efficient materials including silicon-based materials.

### CROSS REFERENCE TO RELATED APPLICATION

This application claims the benefit of pending U.S. provisional patent application No. 62/371,654 filed on Aug. 5, 2016, which is hereby incorporated by reference in its entirety, and further claims the benefit of pending U.S. provisional patent application No. 62/421,228 filed on Nov. 12, 2016, which is hereby incorporated by reference in its entirety.

### BACKGROUND

The present invention relates to devices and methods for economically constructing energy-efficient windows using only three main extrusions. All window types may be constructed using only the three main extrusions.

Existing window systems are typically designed with each window type (single-hung and double-hung vertical windows, horizontal sliders, and fixed) as a separate family of extrusions. And, for each window type there is a main frame, a sash frame, and for vertical or horizontal sliding windows also an interlock mechanism. Finally, there may be other miscellaneous extrusions and hardware.

The traditional window design typically requires seven or more separately designed extrusions for construction of the main and sash framing for each window type. When manufacturing a complete window system for vertical sliders, horizontal sliders, and fixed windows, the number of extrusions maybe as many as 16 or 17. As a result, the tooling costs for new systems are quite high because separate tooling is needed for each of the multiple extrusions for each window type. Therefore, many manufacturers have been reluctant to explore new materials that avoid the defects and issues with existing materials.

Existing materials include wood, vinyl, and aluminum. Each of these has issues. For example, aluminum window frames allow excessive transmission of heat and cold; wood window frames require high maintenance requirements; and vinyl window frames lack the ability to withstand weather extremes.

Another factor in the expense of window manufacturing is the cost of compliance with increasingly strict energy efficiency standards. Window manufacturers typically use materials such as wood, vinyl, and aluminum in an attempt to meet the energy efficiency standards set by government agencies. These government standards have become stricter over time, and in many cases the standards cannot be met using current designs and materials. While newer materials have been developed, the cost of retooling has discouraged their adoption by the industry. Faced with these challenges, manufacturers and architects resort to other, also expensive, solutions such as increased insulation, and coated glass.

The system described herein addresses these problems by greatly simplifying the manufacture of the basic frame and sash combination used in nearly all conventional windows.

Shortcomings in Current Systems: Three primary challenges must be met in order to meet current and anticipated regulatory and structural requirements.

U-values: The rate of heat loss in a window system is measured by its U-value.

The lower the U-value, the greater the window's resistance to heat flow and the greater its insulating properties. The fenestration industry has struggled to find a way to lower the U-value of its products. Thermo-plastic (e.g. vinyl) and wood materials are used in an attempt to do this. However, these materials are of limited effectiveness because of strength limitations under heavy loads. Aluminum has been used for many years to provide the strength required in windy areas and tall buildings. However, aluminum fenestration products have been unable to achieve the lower energy standards because of their high U-values, i.e. they are relatively efficient conductors of heat and cold.

Thermal expansion: Different materials expand (or contract) at different rates as temperatures rise or fall. The higher the Coefficient of Thermal Expansion (COTE), the less desirable is the material in question. It is also undesirable for a window assembly to utilize different materials with widely varying COTEs. The closer the COTEs are, the better the window system performs. For example, the Coefficient of Thermal Expansion (inch/inch/degree F) of Polyvinyl Chloride (PVC) is 0.000071 inch/inch/degree F, aluminum is 0.0000123 inch/inch/degree F and glass is 0.000005 inch/inch/degree F. Not only does Polyvinyl Chloride (PVC) expand and contract up to 14 times that of the other mentioned materials, it also loses its ability to support heavy loads as temperatures rise. This makes PVC, or vinyl, a highly unlikely choice for larger projects in areas with variable ambient temperatures.

Modulus of Elasticity: This is a measure of the strength of a given material when under stress from factors like wind, seismic events, settlement, surrounding structures, etc. The modulus of elasticity of thermal-plastics is 0.3 lbs/inch squared, while for aluminum it is 10,000,000 lbs/inch squared. Thus, aluminum is far stronger than either wood or vinyl. But, aluminum is less desirable for the fenestration industry in both U-values and thermal expansion.

### SUMMARY

The invention comprises a window system for economically making horizontal sliding, vertical sliding, and fixed windows with high energy-efficiency using only three main extrusions, along with some auxiliary hardware. The three extrusions are: (1) the main frame; (2) the sash frame; and (3) the interlock. These three extrusions may be used to form windows of any shape, including triangular, square, rectangular, or any other shape that may be formed using straight lines.

Using only three main extrusions overcomes the disadvantages of existing window assemblies that currently need multiple extrusions, along with auxiliary hardware. The ultimate result is to reduce retooling costs, decrease ongoing production expenses, and enable architects and engineers to more easily meet energy conservation requirements.

The invention described herein may be used with any materials currently used to manufacture windows. In addition, reduced tooling costs allows for implementation of the window system described herein using newer or different materials. For example, ™Xtreme Fiberglass (hereafter “Rovex”) manufactured by deceuninck is a silicon-based material that can be used to create the extrusions described herein. Rovex is described as having U-values 700 times better than aluminum in material-to-material comparisons, while retaining the strength to withstand the load requirements in commercial windows.

The present invention is described using the following examples, which may describe more than one relevant embodiment falling within the scope of the present invention.

### BRIEF DESCRIPTION OF DRAWINGS

FIG. 1A is an elevational view of the main frame extrusion.

FIG. 1B is an elevational view of the sash frame extrusion.

FIG. 1C is an elevational view of the interlock extrusion.

FIG. 2 is an elevational view of an embodiment of the invention, showing a fixed window.

FIG. 3 is cross-section view along the 3-3 line shown in FIG. 2.

FIG. 4A is a cross-section view along lines 4A-4A as shown in FIG. 2.

FIG. 4B is a cross-section view along lines 4B-4B as shown in FIG. 2.

FIG. 5 is a plan view of an embodiment of the invention, showing a horizontal slider.

FIG. 6 is a cross-section view along the 6-6 line shown in FIG. 5, showing the bottom roller assembly in a horizontal slider with two panels that slide.

FIG. 7 is a cross-section view along the 7-7 line shown in FIG. 5, showing the head assembly of a horizontal slider with either one or two sliding panels.

FIG. 8 is a cross-section view along the 8-8 line shown in FIG. 5, showing the jamb assembly of a horizontal slider with either one or two sliding panels.

FIG. 9 is a cross-section view along the 9-9 line shown in FIG. 5, showing the interlock and lock assembly detail of a horizontal slider with either one or two sliding panels.

FIG. 10 is a cross-section view along the 10-10 line shown in FIG. 5

FIG. 11 is a cross-section view along the 11-11 line shown in FIG. 5.

FIG. 12 is an elevational view of a single or double hung window.

FIG. 13 is a cross-section view along the 13-13 line shown in FIG. 5, showing the bottom panel of a single or double hung window, when the bottom panel is down and closed.

FIG. 14 is a cross-section view along the 14-14 line shown in FIG. 5, showing the top panel of a double hung window, when the top panel is up and closed.

FIG. 15 is a cross-section view along the 15-15 line shown in FIG. 5, showing the side frames of a single or double hung window, when the two panels overlap.

FIG. 16 is a cross-section view along the 16-16 line shown in FIG. 5, showing the interlock and lock assembly detail of a either a double hung or single hung window.

### DETAILED DESCRIPTION

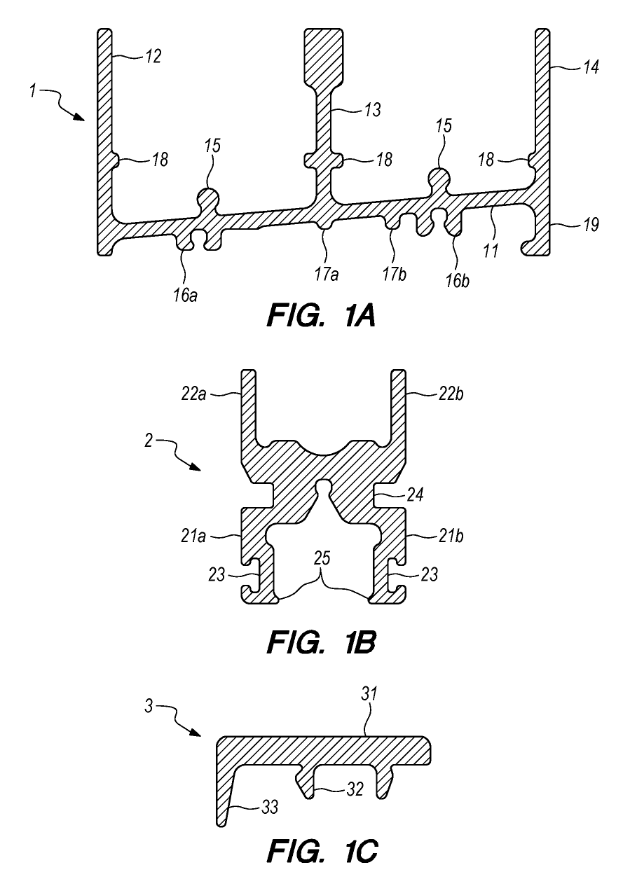

Referring now to FIG. 1, this shows the three main extrusions, the main frame 1, sash frame 2, and interlock 3.

Fixed Window.

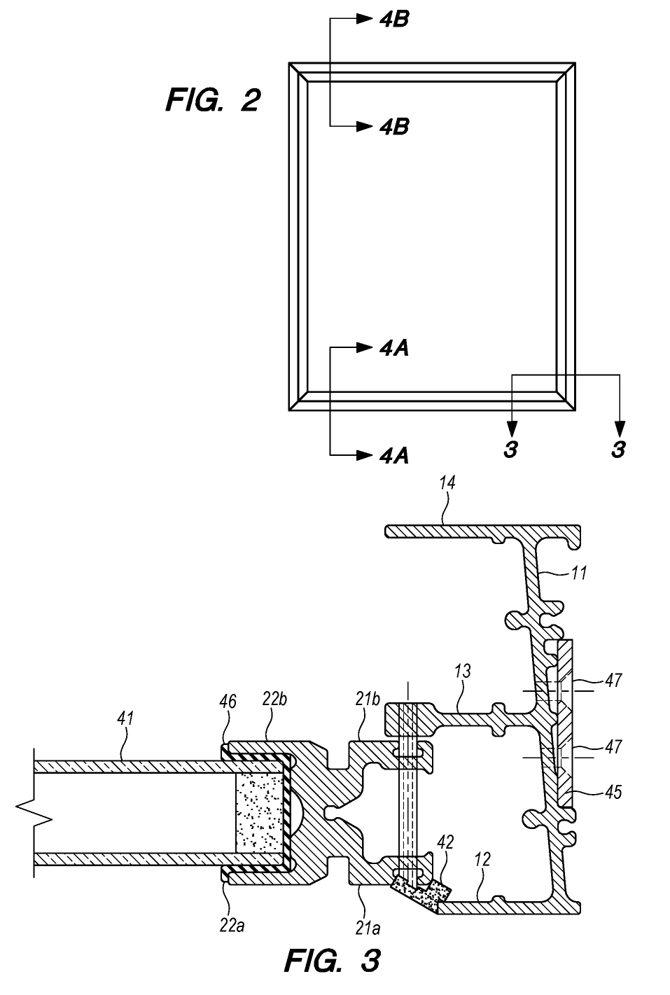

FIGS. 2, 3, and 4 show the use of only two extrusions, the main frame 1 and sash frame 2, to form a fixed window.

The first extrusion, main frame 1, has a width dimension, a height dimension, and a length dimension sufficient for parting off any number members as needed to forming a closed window frame. For example, three members may be parted off to form a triangular window, while four may be parted off to form a rectangular or square window. This main frame member 1 has a cross sectional profile that includes an outward presenting vertical wall extension 12, an inward presenting vertical wall extension relative to window orientation in installation 14, and a lateral back wall 11 bridging the vertical extensions. The lateral back wall forms a sloping surface between the vertical wall extensions. The lateral back wall 11 supports a central vertical wall extension 13, which partition between a first and second window sash channel, where the window sash channels open to the inside of the formed frame.

The second extrusion is sash frame 2, and it has a width dimension, a height dimension, and a length dimension sufficient for parting off the same number of sash frame members as main frame members, and as required to form a closed sash frame. This second extruded member has a cross sectional profile that includes a first vertical edge 21a and a second vertical edge 21b. The vertical edges define a glass channel for accepting window glass. Sash frame further comprises a first vertical leg 21a and second vertical leg 21b.

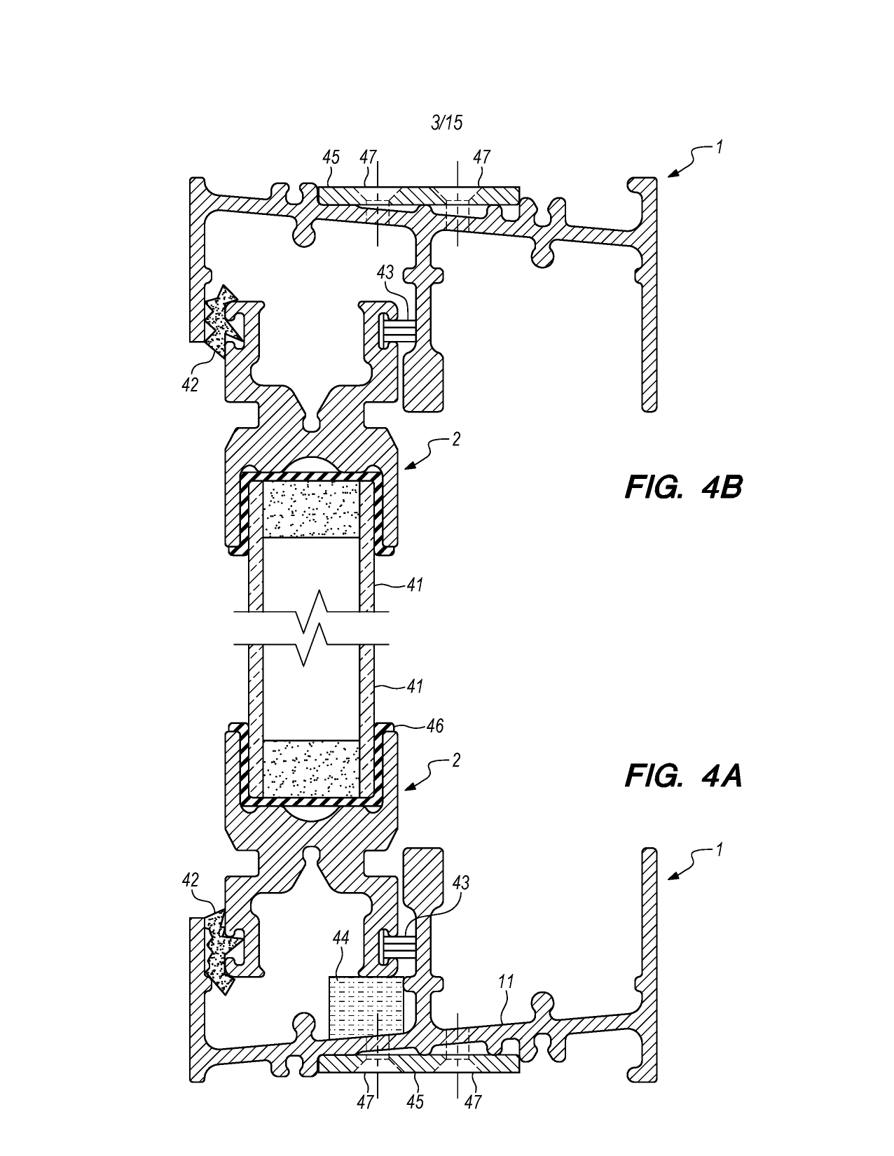

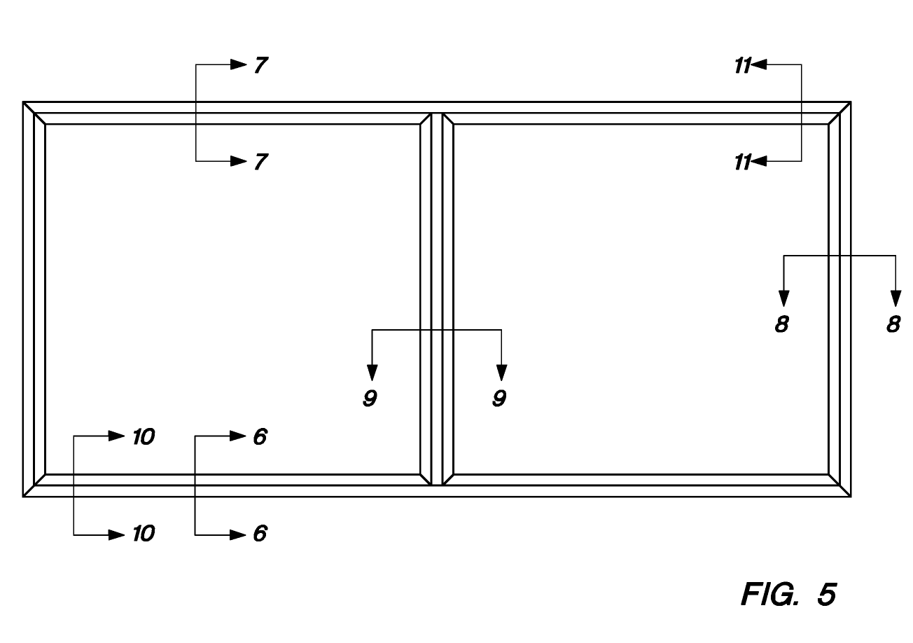

FIG. 2 shows an elevational view of a fixed window. FIG. 3 is a cross-sectional view of the side of a fixed window, along the line 3-3 as shown in FIG. 2. FIG. 4A shows a cross-sectional view of the top of a fixed window, along the 4A-4A line in FIG. 2. FIG. 4B shows a cross-sectional view of the bottom of a fixed window, along the 4B-4B line in FIG. 2. These figures show that main frame 1 is used for all outside framing.

Looking at FIGS. 4A and 4B, the outside of the window is to the left, and the inside of the window is to the right. When main frame 1 is used at the bottom of a fixed window, lateral back wall 11 slopes up from left to right, that is from outside to inside. When main frame 1 is used at the top of a fixed window, lateral back wall 11 slopes down from left (outside) to right (inside), as shown in FIG. 4A. Use of the lateral back wall 11 in main frame 1 allows water or moisture to drain out from the bottom of the window because the lowest part of the lateral back wall 11 is on the outer side of the window frame, as shown in FIG. 4B. One or more small holes may be provided in vertical wall 12 to allow water to drain.

The slope on wall 11 is not typically used to drain moisture on the top or sides because moisture will not accumulate on the top or sides. But, main frame 1, with lateral back wall 11, is used for all sides of the window frame.

When main frame 1 is used for the sides of the window, as shown in FIG. 3, lateral back wall 11 is positioned so that extension 12 is closer to the outside, and extension 14 is closer to the inside.

Lateral back wall 11 is connected with vertical wall extensions 12, 13, and 14, where extension 12 is always closest to the outside. Extensions 12, 13, and 14 are parallel to each other and form a first sash channel and a second sash channel. Sash frame 2 fits into either sash channel. In the fixed window embodiment, the window glass 41 fits into the glass channel defined by vertical edges 22a and 22b. FIGS. 3, 4A and 4B show sash frame 2 with a window panel between extensions 12 and 13 on all four sides of the window. It is apparent that a fixed window panel could instead be supported between extensions 13 and 14 on all four sides of the window.

Glass 41 is held in the glass channel between vertical edges 22a and 22b of sash frame 2, with the assistance of glazing gasket 46. In a preferred embodiment, there may be two sheets of glass 41 forming a double-paned window. In other embodiments, there may be only one sheet of glass, or more than two sheets of glass. The size of the channel formed by vertical edges 22a and 22b may be varied to accommodate the different number of sheets of glass.

Ancillary hardware connects sash frame 2 with main frame 1. As seen in FIGS. 4A and 4B, wedge gasket 42 is between, and connects with, extension 12 and vertical leg 21a of sash frame 2. Weather strip 43 is between, and connects with, extension 13 and weather strip receptacle 23 of sash frame 2. Sash stop 44 is shown below vertical leg 21b, supporting and holding the window in position, although is it apparent that sash stop 44 may be located in any position wherein it supports and holds the window in position. Corner key 45 connects the outside surfaces of the main frame extrusions at the window corners, and is connected to the main frame extrusions with fasteners 47.

Corner key 45 is used in all corners, in all window embodiments. Corner key 45 may fit between lips 16a and 16b, which retain corner key 45 in place. Lip 16a is somewhat shorter than lip 16b, to compensate for the slope of lateral back wall 11 of main frame 1. In addition, spacers 17a and 17b may also be used to support and retain corner key 45 in place. Spacer 17a is somewhat shorter than spacer 17b, to compensate for difference between lateral back wall 11 and the flat surface of the corner key 45.

Lip 19 is part of main frame 1, and is located on the lateral back wall 11 opposite extension 14. When main frame 1 is at the bottom of the window, lip 19 provides additional support to the window and frame, and supports the slope of main frame 1. It is apparent that lip 19 need not be the specific shape shown in the figures. Lip 19 may be any shape that provides support for the higher, inside edge when main frame 1.

In a preferred embodiment, main frame 1 may also comprise protrusions 18. These protrusions are not absolutely necessary. However, the protrusions may provide strength to extensions 12, 13, and 14, while at the same time decreasing the amount of raw material needed to form extensions 12, 13, and 14.

Horizontal Slider.

A horizontal slider may be seen in FIGS. 5-11. FIG. 5 is an elevational view of a horizontal slider. In some embodiments, horizontal slider may have one sliding panel (either on the left or the right). In other embodiments, it may have two sliding panels. In still other embodiments, a horizontal slider may have more than one fixed panel, or it may have more than two sliding panels. As non-limiting examples, a window may have two fixed panels, and one sliding panel, or it may have three sliding panels and one fixed panel. In other words, a horizontal slider may have any combination of fixed and sliding panels.

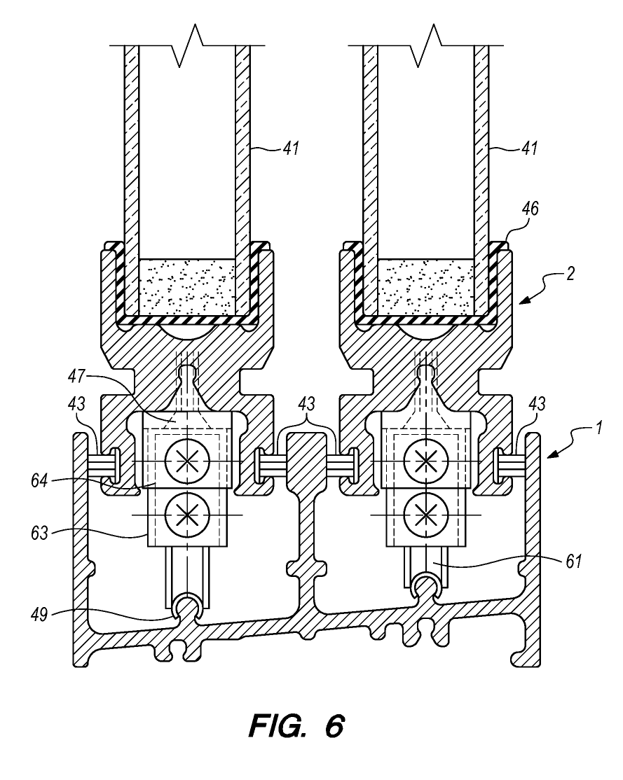

FIG. 6 is a cross-sectional view of the bottom of a horizontal slider with two sliding panels, with roller assemblies at the bottom of each sliding panel. Roller assemblies are known in the art, and placed below sliding panels in horizontal sliders to allow the panel to slide. A roller assembly generally comprises a roller assembly installation bracket 64, and a roller assembly 63 connected with one or more wheels 61.

Roller track spine 15 is part of the main frame 1 extrusion. A first roller track spine 15 located in the sash channel formed by extensions 12 and 13, and a second roller track spine 15 is located in the sash channel formed by extensions 13 and 14. Roller track spine 15 is shaped to connect with roller track 49. In a preferred embodiment, roller track 49 is made from stainless steel and snaps onto roller track spine 15. Roller track 49 is sized to connect with wheel 61. In a preferred embodiment, wheel 61 has a radial groove so that wheel 61 may roll along roller track spine 15 and roller track 49. This allows the sliding window panel to slide left to right, and right to left.

Vertical legs 21a and 21b form a hardware channel. The hardware channel is sized to accept the top of roller assembly installation bracket 64. Fasteners 47 may be used to secure the roller assembly to sash frame 2.

If the horizontal slider has one sliding panel, that means at least one other panel is essentially a fixed window. The top and bottom of the fixed panel would be permanently connected, as shown in FIGS. 4A and 4B. Likewise, the side jamb of the fixed panel would permanently connected, as known in the art.

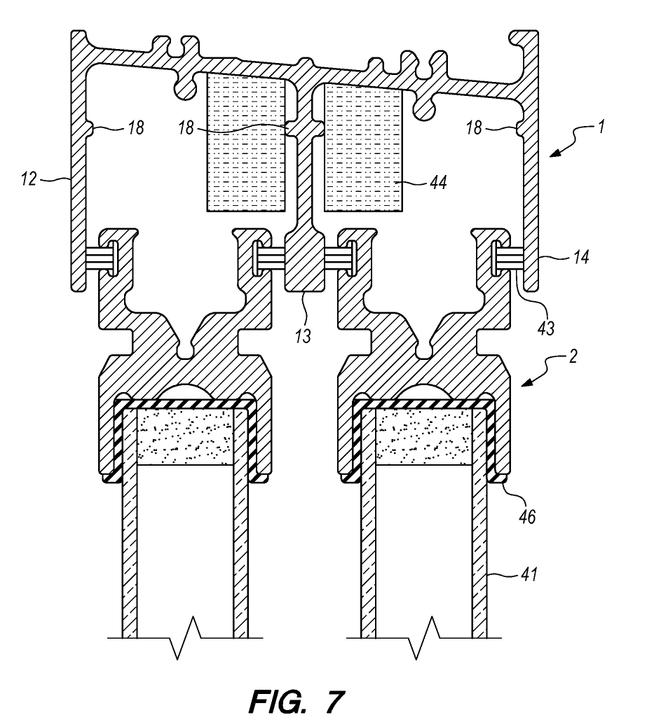

FIG. 7 is a cross-sectional view along line 7-7 in FIG. 5, and shows the top of a horizontal slider with one or two sliding panels, where both panels are slid to the same side.

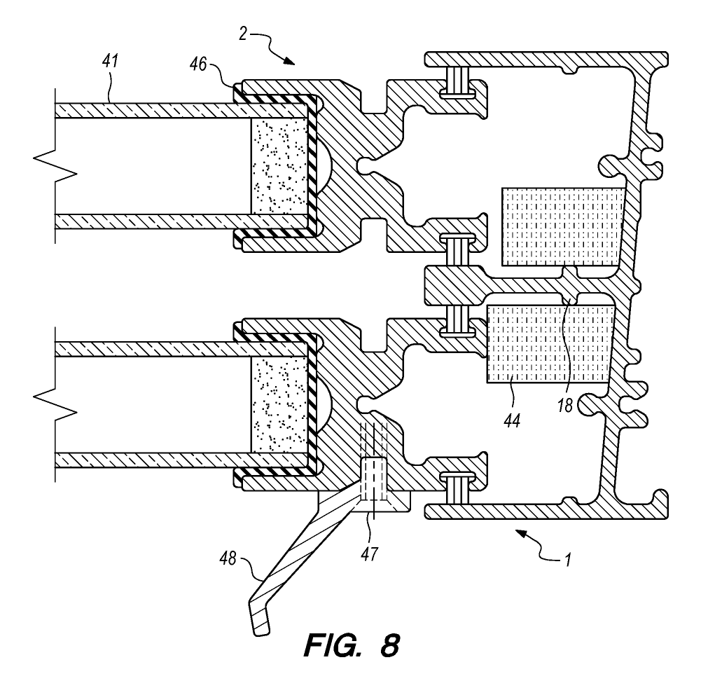

FIG. 8 is a cross-sectional view along line 8-8 as shown in FIG. 5, showing the side jamb in a slider with one or two sliding panels, where both panels are slid to the same side. Handle 48 is shown on the inside panel. Handle 48 is connected with handle groove 24 of sash frame 2. Fastener 47 may be used to secure handle 48 to sash frame 2.

Sash stop 44 may be used to prevent the sliding panel from slamming into the main frame. In a preferred embodiment, sash stop 44 may rest against protrusion 18. It is apparent that sash stop 44 may be located as desired, and does not require protrusion 18.

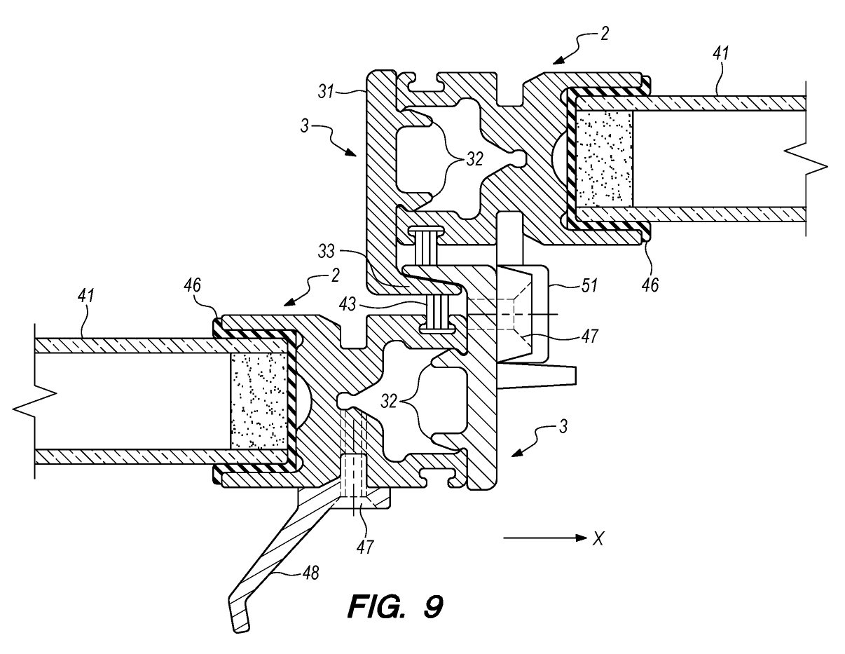

FIG. 9 is a cross-sectional view along line 9-9 as shown in FIG. 5, showing a horizontal slider with one or two sliding panels, with both panels closed. Each panel has interlock 3.

Interlock 3 is a third extruded member with a width dimension, a height dimension, and a length dimension sized to fit within the window frame assembly. The interlock has a cross sectional profile that includes a back strip 31, and two opposing and substantially parallel snap ridges 32 that form snap channel furrow, and an interlock lip wall 33. The snap channel furrow is strategically formed and spaced to facilitate snap in installation, so that snap ridges 32 snap into the hardware channel of the sash frame.

The figures show a preferred embodiment, where the snap ridges have different shapes to facilitate the snap-in action, and allow them to snap into bulbs 25. It is apparent that the snap ridges do not need to be different shapes, and may be any shape that allows for connection between interlock 3 and sash frame 2. In some embodiments, glue may be used to further secure connectors 32 with legs 21.

The interlock lip 33 positioned over and opposed to an interlock lip 33 on an identical inverted interlock extrusion 3 that is connected with the hardware channel of a second sash frame extrusion. Interlock lips 33 are offset with clearance for the interlock lips to overlap in operation.

Lip 33 on a first window panel interlocks with lip 33 on a second window panel when both panels are closed. This secures the two panels together. Weather strip 43 may be located between lip 33 of a first panel, and weather strip receptacle 23 on a second panel. This prevents air from simply flowing between the two window panels.

Handle 48 is on the inside of the window. To open the window, a user may grasp handle 48, and slide the panel in the direction of the “x” arrow. The lips 33 will separate and the panel will slide in the direction of the “x” arrow. The action is the same whether the window has one or two sliding panels. If only one panel slides, then the other panel remains fixed. If both panels slide, then, in a preferred embodiment, the second panel, that is closer to the outside, will also have a handle 48 connected with sash frame 2 on the inside surface of this second panel.

FIG. 9 also shows some ancillary hardware used in sliders, including lock 51 secured to interlock 3 with fastener 47. On the inside window panel, fastener 47 securely connects lock 51 with interlock 3. On the inside window panel, handle 48 is connected to handle groove 24 on interlock 3. In a preferred embodiment fastener 47 connects handle 48 to interlock 3.

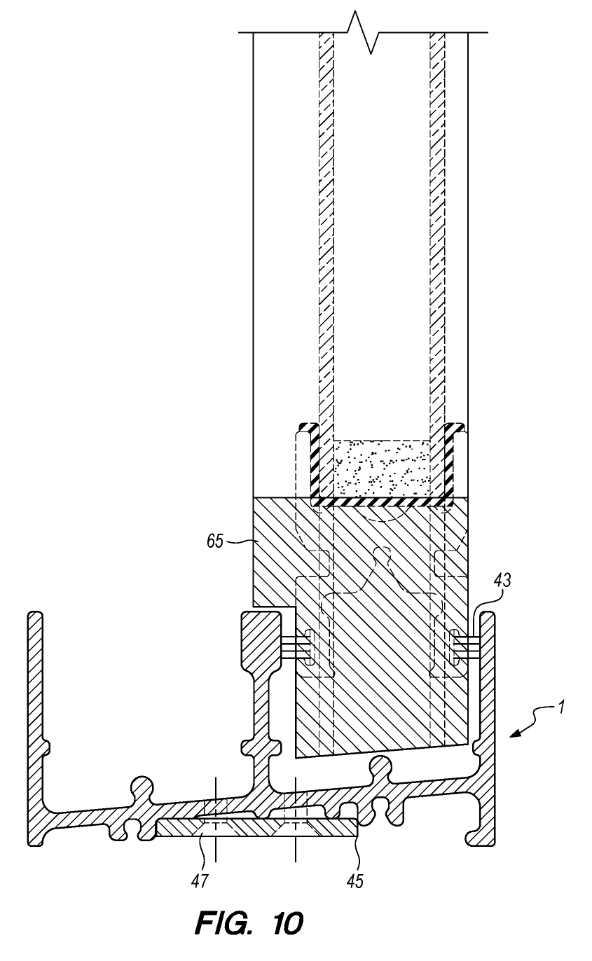

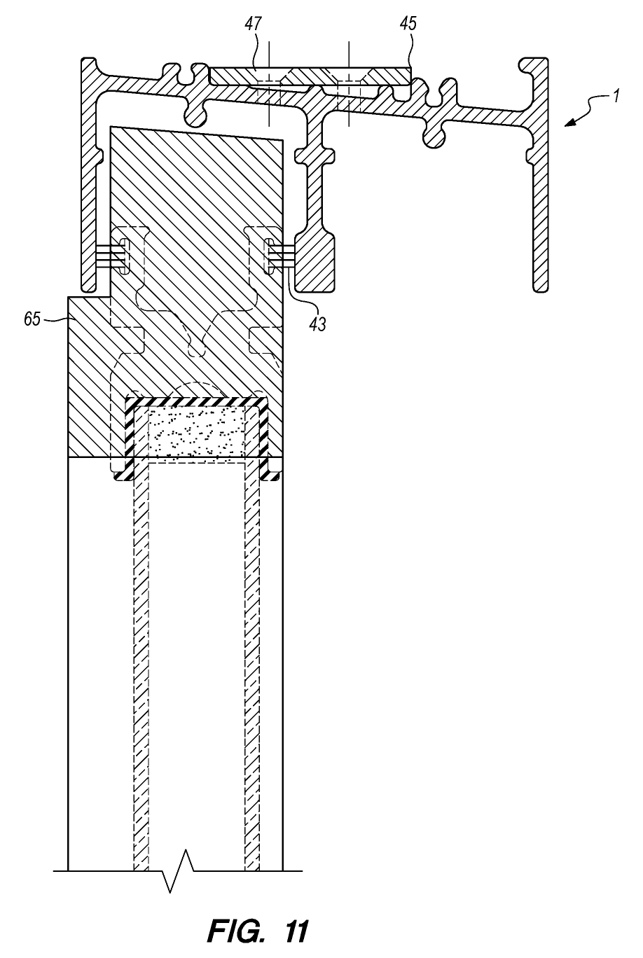

FIGS. 10 shows the bottom main frame of a single panel of a sliding glass window. Also shown is sash filler 65. This piece is ancillary hardware, that may be used to complete the window frame, and may provide additional security and stability to a window frame. Likewise, FIG. 11 shows a top frame of a single panel of a sliding glass window with sash filler 65.

Vertical Hung Windows.

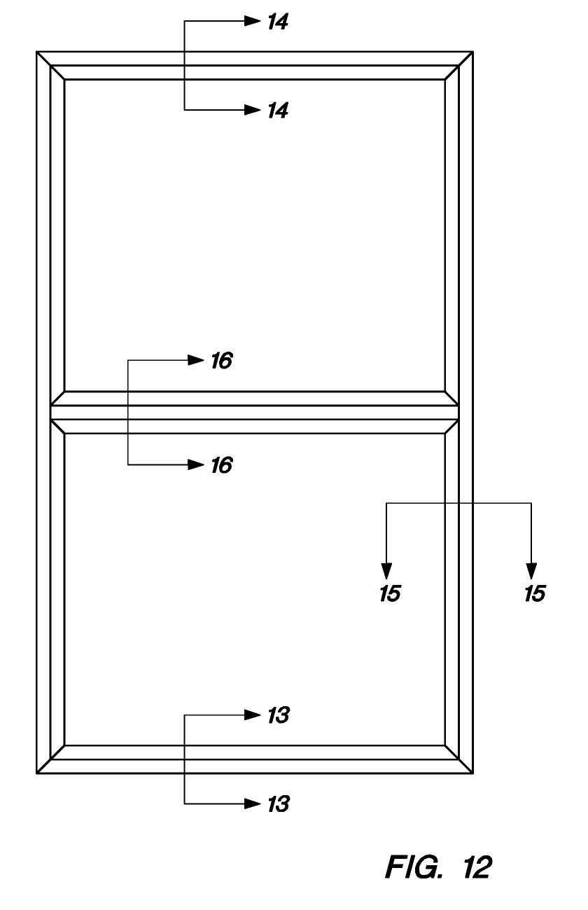

FIGS. 12 to 16 shows use of the invention in vertical hung windows. Vertical hung windows are similar in many respects to horizontal sliders. Vertical double-hung windows are similar to horizontal sliders with two panels that move, and vertical single-hung windows are similar to horizontal sliders with one panel that moves and one panel that does not.

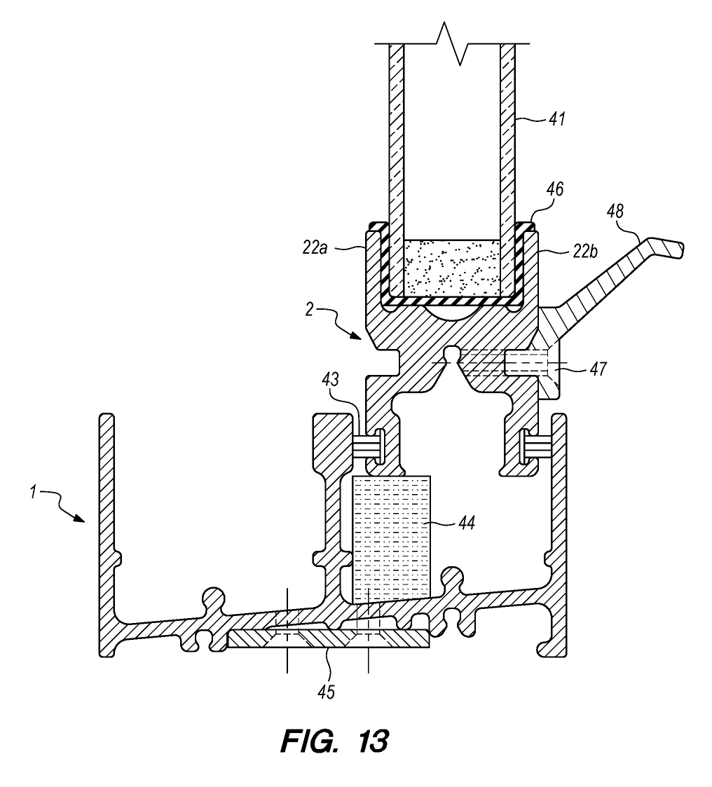

FIG. 12 is an elevational view of a single or double hung window. FIG. 13 shows the bottom window jamb in either a single or double hung window, with the inside bottom window panel all the way down and closed. Main frame 1 forms the bottom frame, as described herein. In the closed position, sash frame 2 rests on sash stop 44, and sash stop 44 provides some support to the window panel. In a preferred embodiment, protrusion 18 holds sash stop 44 in position. In other embodiments, protrusion 18 is not necessary, and sash stop 44 may be held in place with glue or other materials. Leg 22b faces inside, and handle 48 is connected with groove 24, where groove 24 is on the inside underneath leg 22b. Handle 48 may be secured in place by fastener 47. The window may be raised by grasping handle 48 and lifting the window panel up and out of main frame 1. Sash frame 2, along with weather strip 43 will be lifted and the window will open.

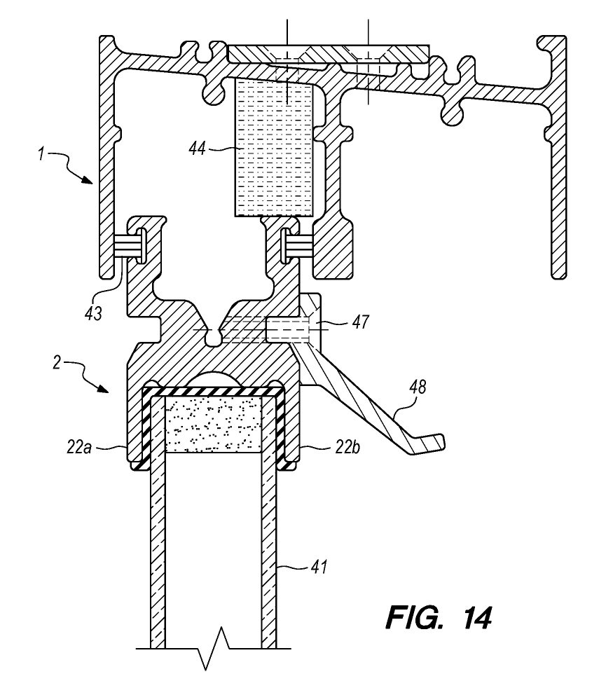

FIG. 14 shows the top window frame in a double hung window, with the top, outer window panel all the way up and closed. Main frame 1 forms the top frame, as described herein. In the closed position, sash frame 2 may connect with sash stop 44. It is apparent that sash stop 44 is not providing support for this top window panel, but sash stop 44 may prevent the top window panel from smashing into the top main frame when being raised. Leg 22b of sash frame 2 faces inside, and handle 48 is connected with groove 24, where groove 24 is on the same side as leg 22b. Handle 48 may be secured in place by fastener 47. The window may be lowered by grasping handle 48 and pulling the window panel down and out of main frame 1. Sash frame 2, along with weather strip 43 will be lowered and the window will open.

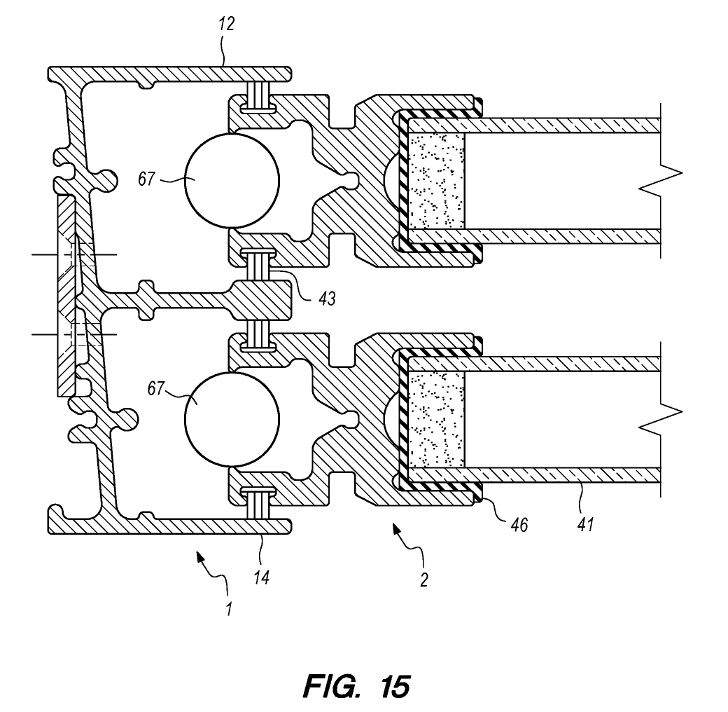

FIG. 15 shows the side window frame of a double hung window, where extension 14 faces inside, and extension 12 faces outside. Main frame 1 and sash frame 2 are connected, and support glass 41 as described herein. Ancillary hardware includes balance 67, which is used to facilitate raising and lowering the window panels. FIG. 15 depicts a double hung window, wherein each window panel that moves may have a balance. In a single hung window, only the moving panel will have a balance.

The cross-sectional views in FIGS. 13 and 14 and 15 also show corner key 45, located in the window corners and used to fasten together the corners of the window.

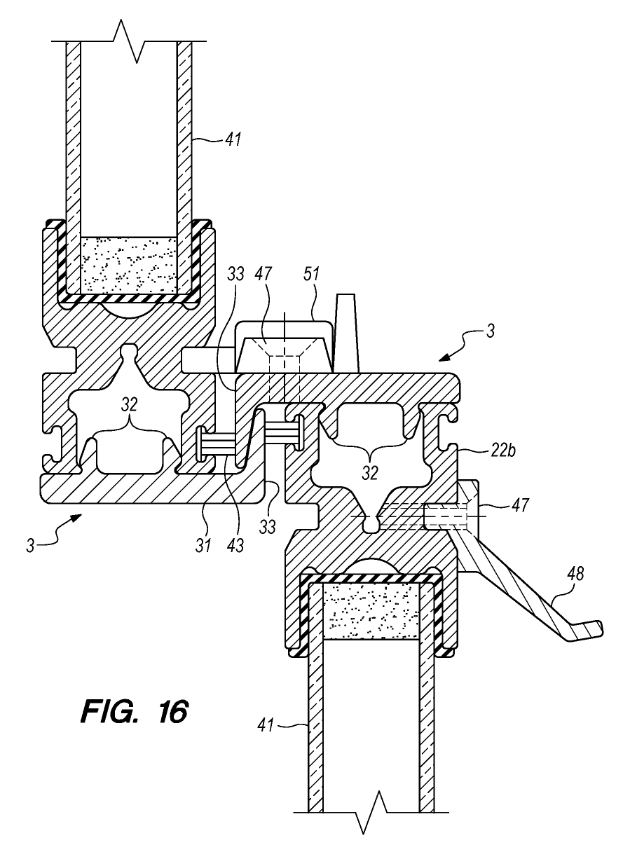

FIG. 16 shows the interlock mechanism for a single or double hung window, and functions as described herein for horizontal sliders. Each panel has interlock 3. Interlock 3 connects the two panels, and is comprised of base 31, with two small connectors 32, and a lip 33.

Lip 33 on a first window panel interlocks with lip 33 on a second window panel when both panels are closed. This secures the two panels together. Weather strips 43 may be located between lip 33 of a first panel, and weather strip receptacle 23 on a second panel. This prevents air from simply flowing between the two window panels.

In FIG. 16, the widow may be opened by grasping handle 48 and raising the window up, so that lip 33 on the inside window panel lifts up and away from lip 33 on the second, outside window panel.

Use of Different Materials.

There are now materials with a modulus of elasticity between 7,900,000 lbs/inch squared and 10,000,000 lbs/inch squared while achieving U-values at or below the standards set by the regulating agencies. For example, deceuninck North America, a PVC extrusion company, describes its Rovex™ as having U-values 700 times better than aluminum in material-to-material comparisons, while retaining the strength to withstand the load requirements in commercial windows. By using an extrusion that is 80% glass, the COTEs and U-values of all of the components of the window system are basically comparable. Accordingly, the U-value of the entire window system would be determined primarily by the glass configuration. For example, if the U-value of the new material is 0.17, and that of the insulated glass unit were 0.24, the whole system U-value would be 0.24, which would meet all of the existing energy requirements in place now, and those proposed in the future.

The invention described herein requires only three main extrusions to assemble vertical sliding windows (single hung and double hung), horizontal sliding windows, and only two main extrusions to assemble fixed windows, where the windows may have any number of outside edges. This means that the tooling costs will be much reduced to make this new window system, while simultaneously achieving existing and anticipated energy-efficiency requirements, and providing the strength needed for all window types.

The above description presents the best mode contemplated in carrying out the invention(s) described herein. However, it is susceptible to modifications and alternate constructions from the embodiments shown in the figures and accompanying description. Consequently it is not intended that the invention be limited to the particular embodiments disclosed. On the contrary, the invention is intended to cover all modifications, sizes and alternate constructions falling within the spirit and scope of embodiments of the invention.

What is claimed is:

1. A window frame assembly comprising:
a first extruded member having a width dimension, a height dimension, and a length dimension sufficient for parting off a number of frame side members required for forming a closed window frame, the first extruded member having a cross sectional profile that includes an outward presenting vertical wall extension, an inward presenting vertical wall extension relative to window orientation in installation, and a lateral back wall bridging the vertical extensions, the lateral back wall presenting at a slope angle between the vertical wall extensions, the lateral back wall supporting a central vertical wall extension serving as a partition between a first and second window sash channel, the window sash channels open to the inside of the formed frame; and
a second extruded member having a width dimension, a height dimension, and a length dimension sufficient for parting off a number of sash frame members required to form a closed sash frame for holding window glass, the second extruded member having a cross sectional profile that includes a first and a second vertical edge, the vertical edges defining a glass channel there between for accepting window glass, a first and second vertical leg, the vertical legs defining a hardware channel there between, the hardware channel adapted to accept one of a roller bracket assembly or a window balance.

2. The window frame assembly of claim 1, fashioned for a fixed window of single or double pane and a single or double window sash having as few as three sides or having a greater number of sides.

3. The window frame assembly of claim 1, wherein the lateral back wall slopes down to the outside of the window frame from the inside of the window frame at the bottom of the frame and openings are provided at the bottom edge of the first vertical wall extension for the purpose of draining moisture including water.

4. The window frame assembly of claim 1, wherein the external surface of the lateral back wall includes a lip with a height dimension located opposite the inward presenting vertical wall extension, and wherein the lip provides support to the lateral back wall.

5. The window frame assembly of claim 1, wherein the second extruded member includes a weather strip furrow for connecting with weather stripping.

6. The window frame assembly of claim 1, wherein a number of corner keys are used to fasten the frame together at a same number of corners of the frame using external fasteners, and one or more sash stops may be provided within one or both sash channels to position each fixed window sash.

7. The window frame assembly of claim 6, wherein the external surface of the lateral back wall includes one or more spacers having a height dimension or in the case of two or more, graduating height dimensions, and wherein the corner keys are held level relative to the angle of slope of the lateral back wall.

8. The window frame assembly of claim 6, wherein the external surface of the lateral back wall includes one or more prongs having a height dimension or in the case of two or more, graduating height dimensions, and wherein the corner keys are held level relative to the angle of slope of the lateral back wall.

9. The window frame assembly of claim 1 further including:
a third extruded member having a width dimension, a height dimension, and a length dimension sufficient to enable application thereof within an inside dimension of the window frame assembly, the third extruded member having a cross sectional profile that includes a back strip having a thickness dimension supporting a snap channel furrow, the snap channel furrow defined by two opposing and substantially parallel snap ridges strategically formed and spaced apart to facilitate snap in installation to the hardware channel of the second extruded member, and an interlock lip wall formed at one side extending perpendicularly from the back strip edge the interlock lip positioned over and opposed to an interlock lip on an identical inverted third extruded member snapped into a hardware channel of a second extruded member, wherein the window frame assembly supports one or more vertically or horizontally sliding sash frames offset with clearance for the interlock lips to overlap in operation.

10. The window frame assembly of claim 9, wherein at least one of the sash channels is occupied by a window panel and at least one of the sash frame hardware channels accepts a roller assembly, the roller assembly including at least one wheel formed with a radial groove to rest on a roller spine provided at substantial center of the sash channel, the roller spine serving as a track for the wheels for a sliding window panel.

11. The window frame assembly of claim 9, wherein a handle groove is formed laterally on one or both sides of the second extruded member used to form the sash frame, the groove of sufficient width and depth for accepting a handle installed therein via a fastener, the handle adapted to be used to slide the sash frame aided by a roller bracket assembly.

12. The window frame assembly of claim 9, wherein the second extruded member includes snap-in bulbs, to facilitate snap-in connection with the snap ridges of the third extruded member.

13. The window frame assembly of claim 9, wherein a lock may be connected with the third extruded member.
